(19) United States
(12) Patent Application Publication
(10) Pub. No.: US 2026/0193927 A1
(43) Pub. Date: Jul. 9, 2026

(54) VEHICLE DOOR CONTROL APPARATUS, METHOD, AND COMPUTER-READABLE MEDIUM

(71) Applicant: NEC Corporation, Tokyo (JP)

(72) Inventors: Koyo SHIBATA, Tokyo (JP); Kazuki INAGAKI, Tokyo (JP); Kohei HIJIKATA, Tokyo (JP); Takuya SETO, Tokyo (JP); Yuta SHIMIZU, Tokyo (JP)

(73) Assignee: NEC Corporation, Tokyo (JP)

(21) Appl. No.: 19/132,124

(22) PCT Filed: Dec. 7, 2022
(86) PCT No.: PCT/JP2022/045129

§ 371 Date: May 22, 2025

(51) Int. Cl. E05F 15/73

(52) U.S. Cl. CPC E05F 15/73; E05F 2015/767; E05Y 2400/858; E05Y 2900/531

(57) ABSTRACT

A door determination means performs a first door determination process to determine a door to be controlled based on an image obtained by imaging a user who intends to get on a vehicle having a plurality of doors. The door control means performs an operation on the door determined by the door determination means. The inquiry means inquires of the user as to whether to permit the operation on the door determined by the door determination means. In a case where a result of the inquiry indicates denial, the door control means performs an operation to cancel the operation performed on the door determined by the door determination means, and performs an operation on a door different from the determined door.

### TECHNICAL FIELD

The present disclosure relates to a vehicle door control apparatus, a vehicle door control method, and a computer-readable medium.

### BACKGROUND ART

As the related art, Patent Literature 1 discloses a smart entry system. In the smart entry system described in Patent Literature 1, a user carries an electronic key and approaches a vehicle. An electronic key authentication apparatus disposed inside the vehicle wirelessly communicates with the electronic key carried by the user to authenticate the electronic key. Furthermore, a camera disposed in the vehicle captures an image of the user who carries the electronic key. In the vehicle, the user directs his/her line of sight to a region corresponding to a door desired to be selected from among a plurality of regions that are preset for doors, respectively. A computing apparatus detects the line of sight of the user from the image captured by the camera, and determines the door selected by the user based on the detected line of sight.

The computing apparatus sends a sign indicating that the door has been ready to be operated to the user by using a voice output apparatus. The voice output apparatus 20 outputs a confirmation message such as “is it ok to open the driver's seat door?” to inquire of the user as to whether it is okay to unlock and open the determined door. In a case where the user has not diverted his/her line of sight from the region at which the user was looking, a door unlock apparatus unlocks the door selected by the user. In a case where the user's line of sight diverts from the region at which the user was looking, the computing apparatus determines that the user has denied the sign indicating that the door has been ready to be operated. In this case, the user manually unlocks the door by touching the handle of the door that the user desires to open.

### CITATION LIST

### Patent Literature

Patent Literature 1: Japanese Unexamined Patent Application Publication No. 2008-2095

### SUMMARY OF INVENTION

### Technical Problem

In Patent Literature 1, the computing apparatus sends a sign indicating that the door has been ready to be operated to the user, and the user can know which door is to be operated by listening to the confirmation message. In a case where the door determined by the computing apparatus is different from the door desired to be selected by the user, the user can avoid operating a wrong door by diverting his/her line of sight. However, in Patent Literature 1, in a case where the user denies the sign indicating that the door has been ready to be operated to the user, the door is not automatically unlocked, and the user needs to manually unlock the door that the user desires to open by touching the door. Therefore, it is desirable to further enhance convenience in an apparatus that controls a vehicle door.

In view of the above circumstances, an object of the present disclosure is to provide a vehicle door control apparatus, a vehicle door control method, and a computer-readable medium capable of enhancing user's convenience in vehicle door control.

### Solution to Problem

To achieve the aforementioned object, the present disclosure provides a vehicle door control apparatus as a first aspect. The vehicle door control apparatus includes: a door determination means for performing a first door determination process to determine a door to be controlled based on an image obtained by imaging a user who intends to get on a vehicle having a plurality of doors; a door control means for performing an operation on the determined door; and an inquiry means for inquiring of the user as to whether to permit the operation on the door. In a case where a result of the inquiry indicates denial, the door control means performs an operation to cancel the operation performed on the determined door, and performs an operation on a door different from the determined door.

The present disclosure provides a vehicle door control method as a second aspect. A vehicle door control method includes: performing a first door determination process to determine a door to be controlled based on an image obtained by imaging a user who intends to get on a vehicle having a plurality of doors; performing an operation on the determined door; inquiring of the user as to whether to permit the operation on the door; in a case where a result of the inquiry indicates denial, performing an operation to cancel the operation performed on the determined door; and performing an operation on a door different from the determined door.

The present disclosure provides a computer-readable medium as a third aspect. A non-transitory computer-readable medium stores a program for causing a processor to execute: performing a first door determination process to determine a door to be controlled based on an image obtained by imaging a user who intends to get on a vehicle having a plurality of doors; performing an operation on the determined door; inquiring of the user as to whether to permit the operation on the door; in a case where a result of the inquiry indicates denial, performing an operation to cancel the operation performed on the determined door; and performing an operation on a door different from the determined door.

### Advantageous Effects of Invention

The vehicle door control apparatus, the vehicle door control method, and the computer-readable medium according to the present disclosure can enhance user's convenience in vehicle door control.

### BRIEF DESCRIPTION OF DRAWINGS

FIG. 1 is a block diagram illustrating an example of a schematic configuration of a vehicle door control apparatus according to the present disclosure.

FIG. 2 is a block diagram illustrating a vehicle door control apparatus according to an example embodiment of the present disclosure.

FIG. 3 is a flowchart illustrating an operation procedure of the vehicle control door apparatus.

FIG. 4 is a block diagram illustrating a hardware configuration of the vehicle control apparatus.

### EXAMPLE EMBODIMENT

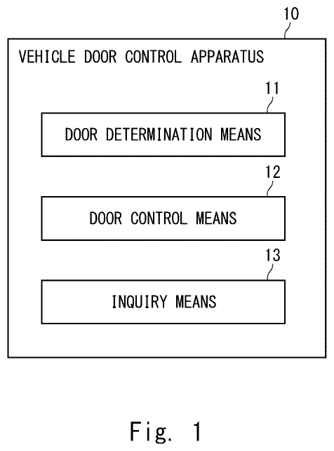

Prior to describing example embodiments of the present disclosure, an outline of the present disclosure will be described. FIG. 1 illustrates an example of a schematic configuration of a vehicle door control apparatus according to the present disclosure. The vehicle door control apparatus 10 includes a door determination means 11, a door control means 12, and an inquiry means 13.

The door determination means 11 performs a first door determination process based on an image obtained by capturing an image of a user who intends to get on a vehicle, and determines a door to be controlled among a plurality of doors of the vehicle. The door control means 12 performs an operation on the door determined by the door determination means 11. The inquiry means 13 inquires of the user as to whether to permit the operation on the door performed by the door control means 12. In a case where the result of the inquiry indicates denial, the door control means 12 performs an operation to cancel the operation performed on the door determined in the first door determination process. In addition, the door control means 12 performs an operation on a door different from the door determined in the first door determination process.

In the present disclosure, in a case where the result of the inquiry acquired by the inquiry means 13 indicates denial, the door control means 12 performs an operation to cancel the operation performed on the door determined in the first door determination process, and performs an operation on a door different from the door determined in the first door determination process. In the present disclosure, in a case where the door determined as a door to be controlled in the first door determination process is different from the door that the user wants to operate, the door control means 12 performs an operation on another door. In this way, even in a case where the door determined as a door to be controlled in the first door determination process is different from the door that the user wants to operate, the user does not need to touch the vehicle. Therefore, the vehicle door control apparatus 10 can enhance the user's convenience in the vehicle door control.

Hereinafter, the example embodiments of the present disclosure will be described in detail with reference to the drawings. Note that, in the following description and drawings, omission and simplification are made as appropriate for clarity of description. Furthermore, the same elements and similar elements are denoted by the same reference signs throughout the drawings, and redundant description is omitted as necessary.

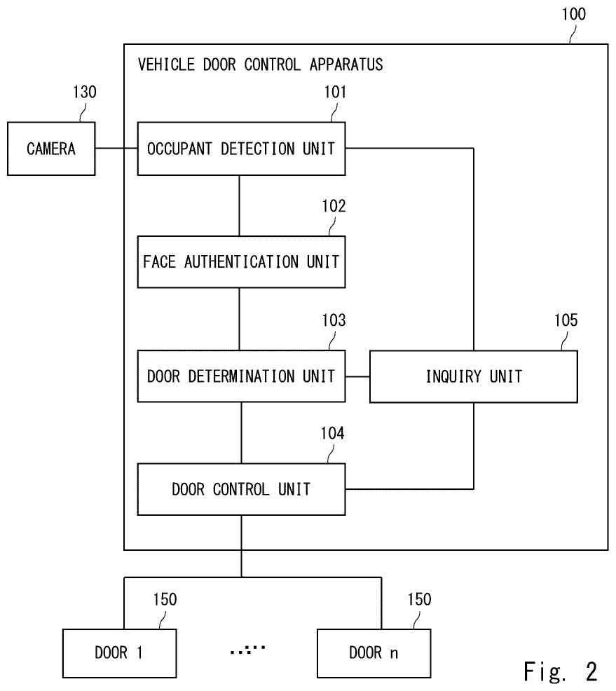

FIG. 2 illustrates a vehicle door control apparatus according to an example embodiment of the present disclosure. The vehicle door control apparatus 100 includes an occupant detection unit 101, a face authentication unit 102, a door determination unit 103, a door control unit 104, and an inquiry unit 105. The vehicle door control apparatus 100 can be physically configured as an apparatus including, for example, one or more memories and one or more processors. At least some of functions of the units in the vehicle door control apparatus 100 may be implemented by one or more processors operating according to a command read from one or more memories. The vehicle door control apparatus 100 is mounted on, for example, a vehicle. The vehicle door control apparatus 100 corresponds to the vehicle door control apparatus 10 illustrated in FIG. 1.

The occupant detection unit 101 acquires a camera image from a camera 130. The camera 130 is a camera mounted on the vehicle to capture an image of a region around the vehicle. The camera 130 captures an image of a person who intends to get on the vehicle, that is, an occupant. The occupant of the vehicle is also referred to as a user. The camera 130 may be embedded, for example, in a B-pillar of the vehicle, that is, a pillar between a front seat door and a rear seat door.

Note that, although only one camera 130 is illustrated in FIG. 2, the number of cameras 130 is not limited to one. The occupant detection unit 101 may acquire camera images from a plurality of cameras 130, respectively. For example, the occupant detection unit 101 may acquire camera images from a camera that captures an image a region left to the vehicle, a camera that captures an image of a region right to the vehicle, and a camera that captures an image of a region behind the vehicle, respectively.

The occupant detection unit 101 detects the user who intends to get on the vehicle using the camera image. For example, the occupant detection unit 101 extracts a face image or a face region of a person near the vehicle from the camera image. In a case where the face image or the face region is extracted, the occupant detection unit 101 determines that the user has been detected.

The face authentication unit 102 authenticates the user detected by the occupant detection unit 101. In the present example embodiment, the face authentication unit 102 authenticates the user by face authentication using the camera image of the camera 130. For example, a face image of a person who is permitted to get on the vehicle or a feature amount extracted from the face image is registered in the face authentication unit 102. The face authentication unit 102 compares a face image included in the camera image or a feature amount extracted from the face image with the registered face image or feature amount. The face authentication unit 102 calculates a verification score indicating a degree of similarity between the face image included in the camera image or the feature amount extracted from the face image and the registered face image or feature amount. The face authentication unit 102 determines that the face authentication of the user is successful if the verification score is higher than or equal to a predetermined threshold.

The door determination unit 103 performs a first door determination process of determining a door to be controlled based on the camera image. In the first door determination process, the door determination unit 103 detects, for example, at least one of a position of the user, a line of sight of the user, and a gesture of the user from the camera image. The door determination unit 103 determines a door to be controlled based on the detected at least one of the position of the user, the line of sight of the user, and the gesture of the user. The door determination unit 103 may determine a door to be controlled according to a combination of the detected position of the user, the detected line of sight of the user, and the detected gesture of the user.

In a case where the door to be controlled is determined based on the position of the user, the door determination unit 103 detects the position of the user from the camera image. For example, the door determination unit 103 determines whether the user is approaching the vehicle from the right to the vehicle or approaching the vehicle from the left to the vehicle. The door determination unit 103 may further determine whether the user is moving toward the front seat door or the rear seat door of the vehicle. For example, the door determination unit 103 holds a table indicating a correspondence relationship between a position of the user and a door to be controlled. The door determination unit 103 may determine a door to be controlled according to a position of the user using the table. Alternatively, the door determination unit 103 may determine a door closest to the position of the user as the door to be controlled.

In a case where the door to be controlled is determined based on the line of sight of the user, the door determination unit 103 detects the user's eyes from the image of the face region in the camera image, that is, the face image, and detects which direction the user's eyes are facing toward. The line of sight can be detected using any known algorithm. A plurality of regions corresponding to a plurality of doors 150 are set in the vehicle. The door determination unit 103 determines whether the user is looking at a region corresponding to a specific door based on the detected line of sight of the user. For example, in a case where the user has looked at the region corresponding to the specific door for a predetermined time or more, the door determination unit 103 may determine the specific door as a door to be controlled.

In a case where the door to be controlled is determined based on the gesture of the user, the door determination unit 103 detects physical expressions such as a posture, a head movement, a hand movement, and a leg movement from the camera image. For example, the door determination unit 103 holds a table indicating a correspondence relationship between a gesture and a door to be controlled. Referring to the table, the door determination unit 103 determines whether the physical expressions of the user indicate a specific gesture associated with a specific door. In a case where the physical expressions of the user indicate the specific gesture, the door determination unit 103 determines the door associated with the specific gesture as a door to be controlled. The door determination unit 103 may determine one or more doors 150 among the plurality of doors 150 provided in the vehicle as doors to be controlled. The door determination unit 103 corresponds to the door determination means 11 illustrated in FIG. 1.

In a case where the user has been successfully authenticated by the face authentication unit 102, the door control unit 104 performs an operation on the door determined by the door determination unit 103. For example, the door control unit 104 unlocks the door determined by the door determination unit 103. The door control unit 104 may open the door as well as unlocking the door. For example, in a case where the door is an electric sliding door, the door control unit 104 transmits a control signal to a controller such as an electronic control unit (ECU) that controls the electric sliding door to control a motor that drives the electric sliding door. For example, in a case where the door is a hinge door, the door control unit 104 may open the door via a certain mechanism. The door control unit 104 corresponds to the door control means 12 illustrated in FIG. 1.

The inquiry unit 105 inquires of the user as to whether to permit the operation on the door determined by the door determination unit 103. The inquiry unit 105 notifies the user of the door to be operated, for example, using voice, light, or the like, and inquires of the user as to whether to permit the operation on the door. The inquiry unit 105 may notify the user of the door to be operated by causing the door control unit 104 to perform an operation to half-open the door determined by the door determination unit 103.

The inquiry unit 105 acquires a reaction of the user to the inquiry as a result of the inquiry. The inquiry unit 105 acquires the result of the inquiry based on, for example, a camera image. For example, the inquiry unit 105 may detect a gesture of the user from the camera image and acquire a result of the inquiry according to the detected gesture. For example, in a case where the user shakes his/her head vertically, the inquiry unit 105 acquires “yes” as an inquiry result. On the other hand, in a case where the user shakes his/her head sideways, the inquiry unit 105 acquires “no” as an inquiry result. The inquiry unit 105 corresponds to the inquiry means 13 illustrated in FIG. 1.

In a case where the result of the inquiry acquired by the inquiry unit 105 indicates denial, the door control unit 104 performs an operation to cancel the operation performed on the door determined as a door to be controlled in the first door determination process. In addition, the door control unit 104 performs an operation on a door different from the door determined as a door to be controlled in the first door determination process. For example, the door control unit 104 may perform an operation to closing a door that has been half-opened in the inquiry to the user, and may open a door different from the door. In a case where the result of the inquiry indicates affirmation, the door control unit 104 may open the door that has been half-opened in the inquiry to the user.

In a case where the result of the inquiry acquired by the inquiry unit 105 indicates denial, the door determination unit 103 may perform a second door determination process based on a camera image and determine a door to be controlled again. In the second door determination process, the door determination unit 103 detects, for example, at least one of a position of the user, a line of sight of the user, and a gesture of the user from the camera image. The door determination unit 103 determines a door to be controlled again based on the detected at least one of the position of the user, the line of sight of the user, and the gesture of the user. In the second door determination process, the door determination unit 103 can determine a door different from the door determined in the first door determination process as a door to be controlled. The door control unit 104 performs an operation on the door determined as a door to be controlled in the second door determination process.

Here, the first door determination process and the second door determination process may have different correspondence relationships between the position of the user, the line of sight of the user, or the gesture of the user and the door to be controlled. For example, the operation performed by the user to designate a certain door in the first door determination process may be different from the operation performed by the user to designate the door in the second door determination process. In the second door determination process, the door determination unit 103 may detect the line of sight of the user and the gesture of the user in a shorter time than in the first door determination process. It is considered that the second door determination process is performed in a state where the user is closer to the vehicle than the first door determination process. In a case where the line of sight of the user and the gesture of the user are detected in a shorter time, it is possible to shorten the time during which the user waits until another door is operated.

In the first door determination process, the door determination unit 103 may determine a first candidate door and a second candidate door as candidates for the door to be controlled, and determine the first candidate door as the door to be controlled. In this case, in a case where the result of the inquiry acquired by the inquiry unit 105 indicates denial, the door determination unit 103 may determine the second candidate door as the door to be controlled without performing the second door determination process.

In the present example embodiment, in a case where the user approaches the vehicle, the door determination unit 103 may perform the first door determination process after the distance between the user and the vehicle becomes within a first distance. In other words, in a case where the user approaches the vehicle within the first distance, the door determination unit 103 may perform the first door determination process to determine a door to be controlled. Similarly, the face authentication unit 102 may authenticate the user by face authentication after the distance between the user and the vehicle is within the first distance. The determination of the door to be controlled by the door determination unit 103 and the face authentication by the face authentication unit 102 may be performed in parallel.

Further, the door control unit 104 may operate the door after the distance between the user and the vehicle is within a second distance shorter than the first distance. In addition, before the door control unit 104 operates the door to be controlled, the inquiry unit 105 may notify the user of the door determined as an object to be controlled in the first door determination process, and may inquire of the user as to whether to permit the operation on the door. That is, the inquiry unit 105 may inquire of the user as to whether to permit the operation on the door if the distance between the user and the vehicle is longer than the second distance.

For example, the door determination unit 103 determines a door to be controlled and the face authentication unit 102 performs face authentication in a case where the user approaches the vehicle within a distance of 5 m. The inquiry unit 105 inquires of the user as to whether to permit the operation on the door determined by the door determination unit 103. In the inquiry, the door control unit 104 may half-open the door determined by the door determination unit 103.

The door control unit 104 operates the door in a case where the user approaches the vehicle within a distance of 1 m. For example, the door control unit 104 performs an operation to open the half-opened door. In this case, the determination of the door to be controlled, the face authentication, and the acquisition of the inquiry result can be completed before the user approaches the vehicle, and the door can be operated after the user sufficiently approaches the vehicle.

In a case where the inquiry unit 105 acquires an inquiry result indicating that the user denies the operation on the door, and the operation on the door determined in the first door determination process has already been performed, the door control unit 104 performs an operation to cancel the performed operation. For example, the door control unit 104 performs an operation to close the door that has been half-opened in the inquiry. The door determination unit 103 performs a second door determination process to determine a door to be controlled. The door control unit 104 performs an operation on the door determined in the second door determination process.

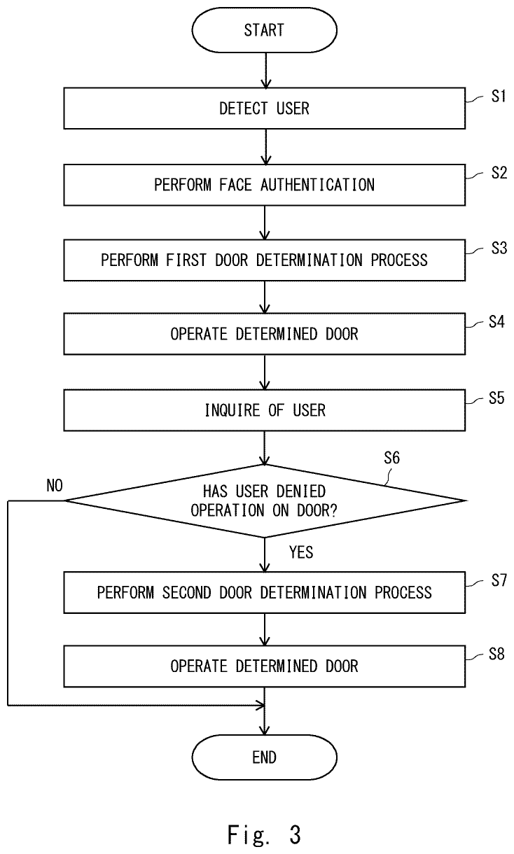

Next, an operation procedure will be described. FIG. 3 illustrates an operation procedure of the vehicle door control apparatus 100. The operation procedure of the vehicle door control apparatus 100 corresponds to a vehicle door control method. The occupant detection unit 101 detects a user around the vehicle based on a camera image of the camera 130 (step S1). The face authentication unit 102 performs face authentication on the user detected in step S1 (step S2). The door determination unit 103 performs a first door determination process to determine a door to be controlled (step S3). In step S3, the door determination unit 103 may detect a line of sight or a gesture of the user, and determine a door to be controlled based on the detected line of sight or gesture.

The door control unit 104 performs an operation on the door determined in step S3 (step S4). The inquiry unit 105 inquires of the user as to whether to permit the operation on the door determined in step S3 (step S5). For example, in step S4, the inquiry unit 105 may cause the door control unit 104 to perform an operation to half-open the door determined in step S3 and notify the user of the door determined in step S3. In step S5, the inquiry unit 105 may inquire of the user as to whether to permit the operation on the door by outputting a message such as “is it okay to open the driver's seat door?” from a speaker.

The user performs an operation indicating a reaction to the inquiry. In a case where the door that the user desires to open is the door determined in step S3, the user makes a motion to affirm the operation on the door. On the other hand, in a case where the door that the user desires to open is different from the door determined in step S3, the user makes a motion to deny the operation on the door. The inquiry unit 105 determines whether the user has denied the operation on the door (step S6). In a case where the user affirms the operation on the door, the process ends. In a case where the user affirms the operation on the door, the door control unit 104 may perform an operation to open the half-opened door.

In a case where the user denies the operation on the door, the user performs an operation to designate another door. In a case where the user denies the operation on the door, the door determination unit 103 performs a second door determination process to determine a door to be controlled again (step S7). A motion indicating denial as an inquiry result and a motion for designating another door may be performed simultaneously. In addition, in a case where the user makes a motion for designating another door, in step S6, the inquiry unit 105 may determine that the user denies the operation on the door determined in the first door determination process. The door control unit 104 performs an operation to cancel the operation performed in step S4, and performs the operation on the door determined in step S7 (step S8). For example, in step S8, the door control unit 104 may close the door that has been half-opened in the inquiry, and may open the door determined in step S7.

In the present example embodiment, in a case where an occupant is detected, the door determination unit 103 performs a first door determination process to determine a door to be controlled. The door control unit 104 performs an operation on the door determined in the first door determination process. The inquiry unit 105 inquires of the user as to whether to permit the operation on the door determined in the first door determination process. The door determination unit 103 performs a second door determination process to determine a door to be controlled again. In a case where the result of the inquiry indicates denial, the door control unit 104 performs an operation to cancel the operation on the door determined in the first door determination process, and performs an operation on the door determined in the second door determination process. In this way, even if the door determined as a door to be controlled in the first door determination process is different from the door that the user wants to operate, the vehicle door control apparatus 100 can perform an operation on another door according to the reaction of the user to the inquiry. In the present example embodiment, the user can operate the door without touching the vehicle, making it possible to enhance the user's convenience in the vehicle door control.

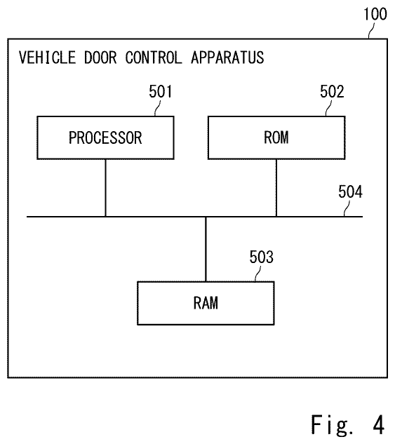

Next, a hardware configuration of the vehicle door control apparatus 100 will be described. FIG. 4 illustrates an example of a hardware configuration of the vehicle door control apparatus 100. The vehicle door control apparatus 100 includes a processor (central processing unit (CPU)) 501, a read only memory (ROM) 502, and a random access memory (RAM) 503. In the vehicle door control apparatus 100, the processor 501, the ROM 502, and the RAM 503 are connected to each other via a bus 504. The vehicle door control apparatus 100 may include other circuits such as a peripheral circuit, a communication circuit, and an interface circuit, although not illustrated.

The ROM 502 is a nonvolatile storage device. For example, a semiconductor storage device such as a flash memory having a relatively small capacity is used for the ROM 502. The ROM 502 stores a program executed by the processor 501.

The program described above includes a group of commands (or software codes) for causing a computer to perform one or more functions described in the example embodiments when the program is read by the computer. The program may be stored in a non-transitory computer-readable medium or a tangible storage medium. As an example and not by way of limitation, the computer-readable medium or the tangible storage medium includes a RAM, a ROM, a flash memory, a solid-state drive (SSD) or any other memory technology, a compact disc (CD), a digital versatile disc (DVD), a Blu-ray (registered trademark) disk or any other optical disk storage, a magnetic cassette, a magnetic tape, a magnetic disk storage, or any other magnetic storage device. The program may be transmitted on a transitory computer-readable medium or a communication medium. As an example and not by way of limitation, the transitory computer-readable medium or the communication medium includes an electric, optical, acoustic, or another form of propagated signal.

The RAM 503 is a volatile storage device. As the RAM 503, various types of semiconductor memory devices such as a dynamic random access memory (DRAM) or a static random access memory (SRAM) are used. The RAM 503 can be used as an internal buffer for transitorily storing data and the like.

The processor 501 loads the program stored in the ROM 502 on the RAM 503, and executes the program. The functions of the units in the vehicle door control apparatus 100 can be implemented by the CPU 501 executing the program.

Note that the vehicle door control apparatus 100 is not necessarily a single apparatus. The vehicle door control apparatus 100 may be configured using a plurality of physically separated apparatuses. Furthermore, the vehicle door control apparatus 100 does not necessarily have all the functions mounted on the vehicle. For example, at least one of the door determination unit 103 and the face authentication unit 102 in the vehicle door control apparatus 100 may be disposed outside the vehicle. In this case, a functional unit disposed inside the vehicle and a functional unit disposed outside the vehicle may transmit and receive information via a wireless communication network.

Although the example embodiments of the present disclosure have been described in detail above, the present disclosure is not limited to the above example embodiments, and the present disclosure also includes changes or modifications made to the above-described example embodiments without departing from the gist of the present disclosure.

### Reference Signs List

10 VEHICLE DOOR CONTROL APPARATUS
11 DOOR DETERMINATION MEANS
12 DOOR CONTROL MEANS
13 INQUIRY MEANS
100 VEHICLE DOOR CONTROL APPARATUS
101 OCCUPANT DETECTION UNIT
102 FACE AUTHENTICATION UNIT
103 DOOR DETERMINATION UNIT
104 DOOR CONTROL UNIT
105 INQUIRY UNIT
130 CAMERA
150 DOOR
501 PROCESSOR
502 ROM
503 RAM
504 BUS

What is claimed is:

1. A vehicle door control apparatus comprising:
at least one memory storing instructions; and
at least one processor configured to execute the instructions to:
perform a first door determination process to determine a door to be controlled based on an image obtained by imaging a user who intends to get on a vehicle having a plurality of doors;
perform an operation on the determined door;
inquire of the user as to whether to permit the operation on the door;
perform, in a case where a result of the inquiry indicates denial, an operation to cancel the operation performed on the determined door; and
perform an operation on a door different from the determined door.

2. The vehicle door control apparatus according to claim 1, wherein the at least processor is configured to execute the instructions to:
Perform, in a case where the result of the inquiry indicates denial, a second door determination process to determine a door different from the door determined in the first door determination process as an object to be controlled based on the image, and
perform an operation on the door determined in the second door determination process.

3. The vehicle door control apparatus according to claim 2, wherein the at least processor is configured to execute the instructions to detect at least one of a position of the user, a line of sight of the user, and a gesture of the user from the image in the first door determination process and the second door determination process, and determine the door to be controlled based on the detected at least one of the position of the user, the line of sight of the user, and the gesture of the user.

4. The vehicle door control apparatus according to claim 3, wherein a correspondence relationship between the at least one of the position of the user, the line of sight of the user, and the gesture of the user and the door to be controlled in the first door determination process is different from a correspondence relationship between the at least one of the position of the user, the line of sight of the user, and the gesture of the user and the door to be controlled in the second door determination process.

5. The vehicle door control apparatus according to claim 1, wherein the at least processor is configured to execute the instructions to acquire a result of the inquiry based on the image.

6. The vehicle door control apparatus according to claim 1, wherein the at least processor is configured to execute the instructions to perform an operation to half-open the door determined in the first door determination process to notify the user of a door to be operated.

7. The vehicle door control apparatus according to claim 6, wherein the at least processor is configured to execute the instructions to open, in a case where a result of the inquiry indicates affirmation, the half-opened door.

8. The vehicle door control apparatus according to claim 6, wherein the at least processor is configured to execute the instructions to perform, in a case where a result of the inquiry indicates denial, an operation to close the half-opened door.

9. A vehicle door control method comprising:
performing a first door determination process to determine a door to be controlled based on an image obtained by imaging a user who intends to get on a vehicle having a plurality of doors;
performing an operation on the determined door;
inquiring of the user as to whether to permit the operation on the door;
in a case where a result of the inquiry indicates denial, performing an operation to cancel the operation performed on the determined door; and
performing an operation on a door different from the determined door.

10. A non-transitory computer-readable medium storing a program for causing a processor to execute:
performing a first door determination process to determine a door to be controlled based on an image obtained by imaging a user who intends to get on a vehicle having a plurality of doors;
performing an operation on the determined door;
inquiring of the user as to whether to permit the operation on the door;
in a case where a result of the inquiry indicates denial, performing an operation to cancel the operation performed on the determined door; and
performing an operation on a door different from the determined door.
